(19) United States
(12) Patent Application Publication
(10) Pub. No.: US 2005/0190734 A1
(43) Pub. Date: Sep. 1, 2005

(54) NAI based AAA extensions for mobile IPv6

(76) Inventors: Mohamed Khalil, Murphy, TX (US); Haseeb Akhtar, Garland, TX (US)

Correspondence Address: D. Scott Hemingway;Storm & Hemingway, LLP, Preston Commons West, Suite 460, 8117 Preston Rd., Dallas, TX, 75225, US

(21) Appl. No.: 11/066,680

(22) Filed: Feb. 25, 2005

Related U.S. Application Data
(60) Provisional application No. 60/548,307, filed on Feb. 27, 2004.
(60) Provisional application No. 60/637,291, filed on Dec. 17, 2004.

(51) Int. Cl. H04Q 7/24

(52) U.S. Cl. 370/338; 370/401

(57) ABSTRACT

The present invention supports a protocol for a mobile node to specifically designate a home agent and Authentication, Authorization, and Accounting (AAA) server to use in a communication session. By specifying the AAA server, a specific security association can be selected to support secure information packet transmission between a specified home agent and a mobile node. The specific home agent and AAA server are designated using a network access identifier extension on a binding update message, and the security association data is transmitted back to the mobile node using an extension to the binding acknowledgment message. The mobile node and the home agent then use the security association generated by the AAA server to support information packet communication between the mobile node and the home agent.

### RELATED APPLICATION DATA

This application is related to Provisional Patent Application Ser. No. 60/548,307 filed on Feb. 27, 2004 and Provisional Patent Application Ser. No. 60/630,291 filed Dec. 17, 2004, and priority is claimed for these earlier filings under 35 U.S.C. § 120. The Provisional Patent Applications are also incorporated by reference into this utility patent application.

### TECHNICAL FIELD OF THE INVENTION

A modified information packet extension for use in a packet-based mobile communication system.

### BACKGROUND OF THE INVENTION

Present-day Internet communications represent the synthesis of technical developments begun in the 1960s. During that time period, the Defense Department developed a communication system to support communication between different United States military computer networks, and later a similar system was used to support communication between different research computer networks at United States universities.

The Internet

The Internet, like so many other high tech developments, grew from research originally performed by the United States Department of Defense. In the 1960s, Defense Department officials wanted to connect different types of military computer networks. These different computer networks could not communicate with each other because they used different types of operating systems or networking protocols.

While the Defense Department officials wanted a system that would permit communication between these different computer networks, they realized that a centralized interface system would be vulnerable to missile attack and sabotage. To avoid this vulnerability, the Defense Department required that the interface system be decentralized with no vulnerable failure points.

The Defense Department developed an interface protocol for communication between these different network computers. A few years later, the National Science Foundation (NSF) wanted to connect different types of network computers located at research institutions across the country. The NSF adopted the Defense Department's interface protocol for communication between the research computer networks. Ultimately, this combination of research computer networks would form the foundation of today's Internet.

Internet Protocols

The Defense Department's interface protocol was called the Internet Protocol (IP) standard. The IP standard now supports communication between computers and networks on the Internet. The IP standard identifies the types of services to be provided to users and specifies the mechanisms needed to support these services. The IP standard also describes the upper and lower system interfaces, defines the services to be provided on these interfaces, and outlines the execution environment for services needed in this system.

A transmission protocol, called the Transmission Control Protocol (TCP), was developed to provide connection-oriented, end-to-end data transmission between packet-switched computer networks. The combination of TCP with IP (TCP/IP) forms a system or suite of protocols for data transfer and communication between computers on the Internet. The TCP/IP standard has become mandatory for use in all packet switching networks that connect or have the potential for utilizing connectivity across network or sub-network boundaries.

A computer operating on a network is assigned a unique physical address under the TCP/IP protocols. This is called an IP address. The IP address can include: (1) a network ID and number identifying a network, (2) a sub-network ID number identifying a substructure on the network, and (3) a host ID number identifying a particular computer on the sub-network. A header data field in the information packet will include source and destination addresses. The IP addressing scheme imposes a sensible addressing scheme that reflects the internal organization of the network or sub-network. All information packets transmitted over the Internet will have a set of IP header fields containing this IP address.

A router is located on a network and is used to regulate the transmission of information packets into and out of computer networks and within sub-networks. Routers are referred to by a number of names including Home Agent, Home Mobility Manager, Home Location Register, Foreign Agent, Serving Mobility Manager, Visited Location Register, and Visiting Serving Entity. A router interprets the logical address of an information packet and directs the information packet to its intended destination. Information packets addressed between computers on the sub-network do not pass through the router to the greater network, and as such, these sub-network information packets will not clutter the transmission lines of the greater network. If an information packet is addressed to a computer outside the sub-network, the router forwards the packet onto the greater network.

The TCP/IP network includes protocols that define how routers will determine the transmittal path for data through the network. Routing decisions are based upon information in the IP header and entries maintained in a routing table. A routing table possesses information for a router to determine whether to accept the communicated information packet on behalf of a destination computer or pass the information packet onto another router in the network or sub-network. The routing table's address data enables the router to accurately forward the information packets.

The routing table can be configured manually with routing table entries or with a dynamic routing protocol. In a dynamic routing protocol, routers update routing information with periodic information packet transmissions to other routers on the network. This is referred to as advertising. The dynamic routing protocol accommodates changing network topologies, such as the network architecture, network structure, layout of routers, and interconnection between hosts and routers. Internet Control Message Protocol (ICMP) information packets are used to update routing tables with this changing system topology.

The IP-Based Mobility System

The Internet protocols were originally developed with an assumption that Internet users would be connected to a single, fixed network. With the advent of portable computers and cellular wireless communication systems, the movement of Internet users within a network and across network boundaries has become common. Because of this highly mobile Internet usage, the implicit design assumption of the Internet protocols has been violated.

In an IP-based mobile communication system, the mobile communication device (e.g. cellular phone, pager, computer, etc.) is called a mobile node. Typically, a mobile node changes its point of attachment to a foreign network while maintaining connectivity to its home network. A mobile node may also change its point of attachment between sub-networks in its home network or foreign network. The mobile node will always be associated with its home network and sub-network for IP addressing purposes and will have information routed to it by routers located on the home and foreign network. Generally, there is also usually a correspondence node, which may be mobile or fixed, communicating with the mobile node.

IP Mobility Protocols

During the formative years since the Internet was first established, Internet Protocol version 4 (IPv4) was recognized and adopted as the standard version of the Internet Protocol. With the advent of mobile IP and proliferation of computers and computer systems linked to the Internet, various limitations in the IPv4 standard and associated procedures have developed and emerged. In response, new standards are evolving and emerging.

The most pressing limitation in the IPv4 standard is the restriction on the number of possible IP addresses imposed by the 32-bit address field size. A newer standard, the Internet Protocol version 6 (IPV6) increases the size of the available address space 400% to 128 bits, which vastly increases the number of available addresses. While the 32-bit address field provides 232 or approximately 4 billion IP address possibilities, a 128-bit field provides 2128 (340×10¹²) IP address possibilities.

A number of benefits emerge from this vastly larger available address field. First, there is little chance of exhausting the number of IP addresses. Second, a large address field allows aggregation of many network-prefix routers into a single network-prefix router. Finally, the large address pool allows nodes to auto configure using simple mechanisms. One practical advantage as a result is elimination of specialized foreign agents to route information packets to a visiting mobile node on a foreign network.

IP Mobility Care-of Addressing

In a mobile IP network, nodes will transmit notification and discovery information packets onto the network to advertise their presence on the network and solicit advertisements from other nodes. While on a foreign network, a mobile node will be assigned a care-of address that will be used to route information packets to the foreign network and the attached mobile node. An advertisement from a router on the foreign network will inform a mobile node that is attached to a foreign network. The mobile node will typically create a care-of address on the foreign network, which it will transmit to its home network in an information packet to register the care-of address. Information packets addressed to the mobile node on the home network have the care-of address added. This information packet containing the care-of address will then be forwarded and routed to the mobile node on the foreign network by a router on the foreign network according to the care-of address.

Mobile IP Extensions

Extensions have been defined in the IP protocol, and extensions can be used in similar protocols, to support transmission of variable amounts of data in an information packet. This includes address information for mobile nodes, routers, and networks. The extension mechanism in IP permits appropriate addressing and routing information to be carried by any information packet, without restriction to dedicated message types such as discovery, notification, control, and routing information packet formats.

The IPv6 header minimizes header overhead. Compared to IPv4, nonessential fields and option fields have been moved to extension headers inserted after the IPv6 header. The extension header mechanism of IPv6 is part of the data payload so that intermediate routers are not affected by processing the extension headers.

The general extension format is found in FIG. 1 in a Type-Length-Value format. As shown in FIG. 1, the Type data field (T) 1 occupies the first 8-bits (one octet) of the general extension. The value of this data field will designate the type of extension. The Length data field (L) 2 occupies the next 8-bits of the extension, and the value assigned is the length of the Value field (V) 3 in octets. The Value data field 3 occupies the remaining bits in the general extension as specified by the Type 1 and Length 2 data values.

Mobile IPv6 Movement Detection and Binding

Upon moving to a new network, a mobile node detects its movement by receipt of a Router Advertisement message from a new router or exceeding the time interval for receiving an expected Router Advertisement message from a linked router. A mobile node can also periodically transmit a Router Solicitation message that will be received by a router on the foreign network and initiate transmission of a Router Advertisement message received by the mobile node.

The Router Advertisement message contains network prefix information that is used to form a care-of address for routing information packets from the home network to the mobile node on the foreign network. A Binding Update message (BU) is used to register the care-of address with the home agent and any active correspondence node communicating with the mobile node. The new binding includes the care-of address, the home address, and a binding lifetime. A Binding Acknowledgment message (BA) is sent in response to the Binding Update message to either accept or reject the Binding Update as an authentication step. A Correspondence Node can send a Binding Request message (BR) to a mobile node to discover the care-of address for the mobile node, and a Binding Update will typically be sent to the Correspondence Node in response. The Binding Request is generally used to refresh a binding nearing expiration of the designated lifetime of the binding. Routers on the networks will maintain the care-of address and home IP address association for the mobile node on a data table, ensuring that information packets can be routed to a mobile node connected to the foreign network.

Authentication, Authorization and Accounting (“AAA”)

In an IP-based mobile communications system, the mobile node changes its point of attachment to the network while maintaining network connectivity. When a mobile node travels outside its home administrative domain, however, the mobile node must communicate through multiple domains in order to maintain network connectivity with its home network. While connected to a foreign network controlled by another administrative domain, network servers must authenticate, authorize and collect accounting information for services rendered to the mobile node. This authentication, authorization, and accounting activity is called “AAA”, and AAA servers on the home and foreign network perform the AAA activities for each network.

Authentication is the process of proving someone's claimed identity, and security systems on a mobile IP network will often require authentication of the system user's identity before authorizing a requested activity. The AAA server authenticates the identity of an authorized user and authorizes the mobile node's requested activity. Additionally, the AAA server will also provide the accounting function including tracking usage and charges for use of transmissions links between administrative domains.

Another function for the AAA server is to support secured transmission of information packets by storing and allocating security associations. Security associations refers to those encryption protocols, nonces, and keys required to specify and support encrypting an information packet transmission between two nodes in a secure format. The security associations are a collection of security contexts existing between the nodes that can be applied to the information packets exchanged between them. Each context indicates an authentication algorithm and mode, a shared key or appropriate public/private key pair, and a style of replay protection.

Under existing procedures, there is a lack of AAA presence in the authentication protocols for Mobile IPv6 and no mechanism to pre-set security association with the mobile node and the home agent. There is a need for a mechanism to designate a specific home agent and AAA server association that allows for pre-setting the security associations or otherwise specifying a given home agent and/or AAA server communication link. This establishes an AAA presence in the authentication protocol for Mobile IPv6 that allows an AAA entity to supply security association data components and enable secure information packet transmissions between the specified mobile node and the home agent.

Under the prior art, it is necessary to go through the AAA entity each time to establish the security associations and secured communication protocol. The invention establishes the security associations at the start of the Mobile IP session that are used throughout the duration of the session without a need to periodically route messages to and from the AAA server to create or maintain a security association. Compared to the prior art, network management is easier, and the protocol and network are more scalable.

### SUMMARY OF THE INVENTION

The invention consists of a new protocol for setting a security association between a mobile node and a home agent using a home AAA server. A set of new extensions to the Mobile IPv6 Binding Update and Binding Acknowledgment message are used to designate a specific home agent and home AAA (AAAH) server and to supply key data to the mobile nodes and home agent from the specified AAAH.

A Network Access Identifier (NAI) based Mobile IPv6 extension is added to the Binding Update and Binding Acknowledgement messages to designate or identify the home agent and/or AAA server to be used in a mobile IP session. By using this extension, the mobile node can select a specific home agent/AAAH pair to use to establish a specific security association for communication between the mobile node and the home agent. The home agent can also function to select a specific AAAH to establish a specific security association for communication between the mobile node and the home agent.

The necessary security key nonces and shared keys to establish the security association are communicated between the AAA server and the mobile node using new extensions to the Binding Update and Binding Acknowledgement message, so that a security association can be created between the mobile node and the home agent. The Binding Update and Binding Acknowledgment message carry the necessary security association AAA data elements between the mobile node and the home agent. This protocol allows dynamic configuration of the security association between the mobile node and the home network.

### BRIEF DESCRIPTION OF THE DRAWINGS

The objects and features of the invention will become more readily understood from the following detailed description and appended claims when read in conjunction with the accompanying drawings in which like numerals represent like elements and in which:

FIG. 1 is a general extension format;

FIG. 2 is a prior art schematic diagram of a mobile IP wireless communication network compatible with Mobile IPv6;

FIG. 3 is the general format for an information packet;

FIG. 4 is the format for an IPv6 Header;

FIG. 5 is the general format for a Mobility Header payload extension;

FIG. 6 is a Binding Update message;

FIG. 7 is a Binding Acknowledgement message;

FIG. 8 is a Network Access Identifier Carrying extension;

FIG. 9 is the message flow of the invention for setting a security association between a specified Home Agent and Mobile Node using an AAAH;

FIG. 10 is a MN-HA Generation Nonce Request Option extension;

FIG. 11 is a MN-HA Generation Nonce Reply Option extension; and

FIG. 12 is a MN-HA Generation Nonce From AAA extension.

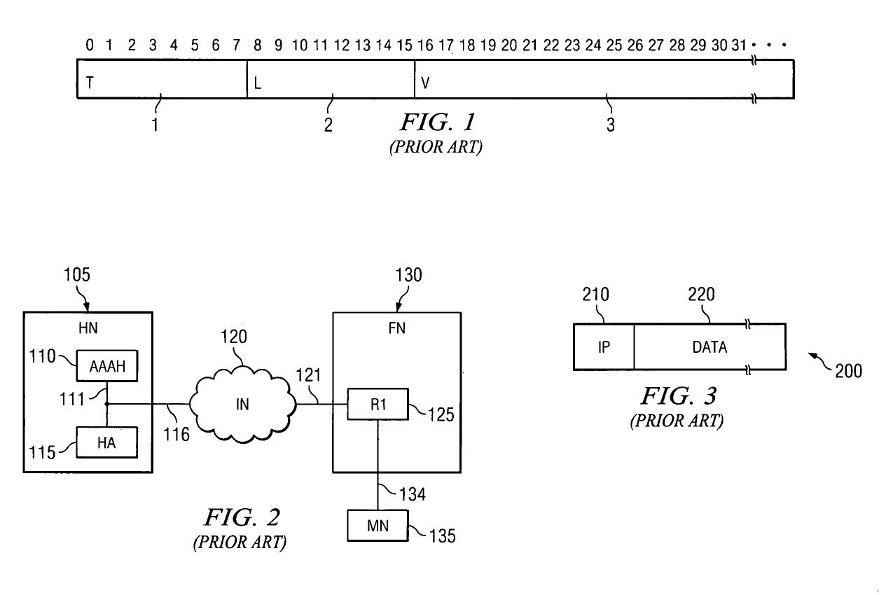

### DETAILED DESCRIPTION OF THE PREFERRED EMBODIMENTS

FIG. 2 shows an embodiment for a mobile IP cellular communication network under the prior art compatible with Mobile IPv6 that can use the invention. A home network 105 consists of a home Authentication, Authorization, and Accounting (AAAH) server 110. The AAAH 110 is connected to the home agent 115 (HA) by communication link 111. Communication link 116 connects the AAAH 110 and HA 115 to the Internet 120. Router 1 (RI) 125 on the Foreign Network (FN) 130 connects to the Internet 120 using communication link 121. The Mobile Node (MN) 135 is coupled to R1 125 using communication link 134. The Mobile Node 135 can be a communication device, such as a cellular phone, a computer, a router, a personal data assistant (PDA) and handheld terminal, or some other type of host. The communication link 134 can be a wireless or wired communication link.

The Mobile Node 135 is associated with the Home Agent 115. Information packets sent to the Mobile Node 135 on the home network 105 are routed to the Mobile Node 135 while linked to the foreign network 130. The Home Agent 115 stores an address association in its memory corresponding to the location of the Mobile Node 135 on the foreign network 130. The address association includes the Internet Protocol address of the Mobile Node 135 on the home network 105 and the care-of address corresponding to the topological location of the router 125. As the Mobile Node 135 moves from network to network, the various routing tables and other data tables must be updated to maintain communication with the Mobile Node 135 thereby ensuring the correct routing of information packets.

When Mobile Node 135 movement results in a change in connectivity, the Mobile Node's 135 care-of address must be updated so that the correct router associations on both the home agent 115 and the RI 125 are maintained. Hand-off procedures involve assignment of a care-of address for the home agent 115 to transmit an information packet through the Internet 120, so that the R1 125 can route the information packet to the connected Mobile Node 135.

The general format of an information packet used on packet-based communication systems is shown in FIG. 3. Information packets use an encoding format of “1” and “0” data bits to build a data stream that a computer can interpret. The information packet 200 has an IP address header 210 that provides routing instructions for transport over an IP communication system. The actual length and configuration of the IP header 210 is dependent on the actual communication protocol being used (e.g. IPv4 or IPv6). The information packet 200 also contains a variable length data field 220 that contains the actual information being transmitted from the originating source to the destination source.

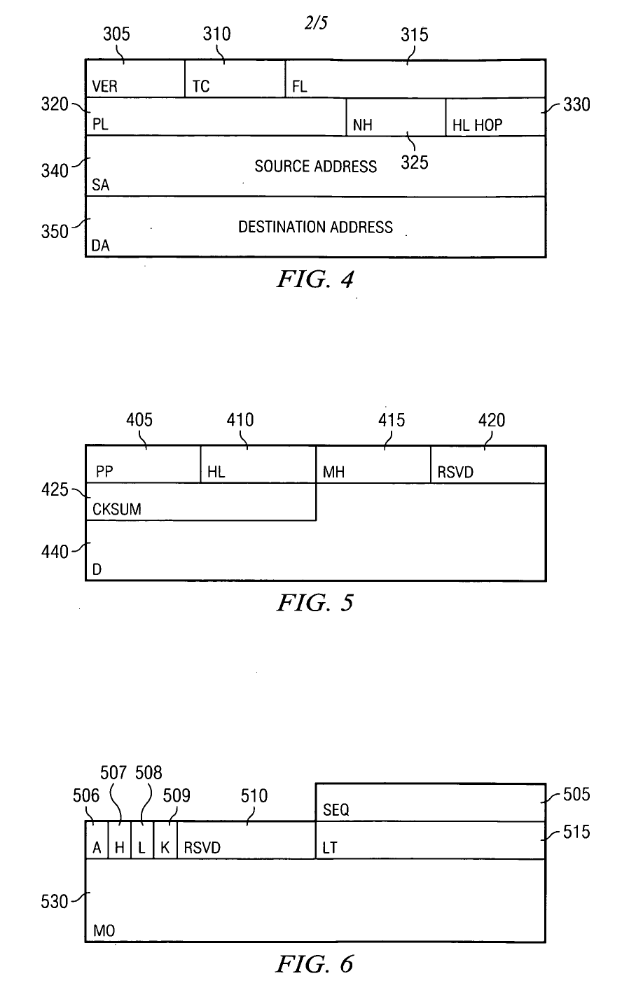

FIG. 4 is the IP header format for the IPv6 protocol. The Version (V) 4-bit data field 305 has a value of “6” and designates the header as an IPv6 protocol packet. The Traffic Class (TC) 8-bit data field 310 is available to identify and distinguish between different classes or priorities of IPv6 packets. The Flow Label (FL) 20-bit data field 315 is used by a source to label sequences of packets for special handling by routers. The Payload Length (PL) 16-bit data field 320 specifies the length of the IPv6 payload in octets or bytes. The Next Header (NH) 8-bit data field 325 identifies the type of header immediately following the IPv6 header. The Hop Limit (HL) 8-bit data field 330 is decremented by 1 for each node that forwards the packet. If the field value reaches zero, then the packet is discarded. The Source Address (SA) 128-bit data field 340 contains the IP address of the originator of the packet, and the Destination Address (DA) 128-bit data field 350 contains the IP address of the intended recipient of the packet.

FIG. 5 is the general format for a Mobility Header payload extension as used in the invention. The Mobility Header is inserted after the IPv6 Header. The Payload Proto (PP) 8-bit data field 405 identifies the type of header immediately following the Mobility Header. The Header Length (HL) 8-bit data field 410 is the length of the Mobility Header in octets or bytes, excluding the first 8 bytes. The MH Type data field 415 identifies the particular mobility message. The Reserved (RSVD) 8-bit field 420 is reserved for future use. The Checksum (CKSUM) 16-bit data field 440 is calculated from the octet string consisting of a “pseudo-header” followed by the entire Mobility Header and is the complement sum of the string. The Message Data (D) variable length data field 440 contains the data specific to the message being communicated to the node.

FIG. 6 shows a Binding Update message (BU) extension format used in the invention. This extension occupies the Message Data data field of FIG. 5. The Sequence Number (SEQ) 16-bit data field 505 is used to sequence Binding Updates received by a receiving node and to match a returned Binding Acknowledgement by a sending node. The Acknowledge (A) one-bit data field 506 is set by the sending mobile node to request a Binding Acknowledgement. The Home Registration (H) one-bit data field 507 is set by the mobile node to request that the receiving node should act as the mobile node's home agent. The Link-Local Address Capability (L) one-bit data field 508 is set when the reported home address has the same interface identifier as the mobile node's link-local address. The Key Management Mobility Capability (K) one-bit data field 509, if cleared, indicates that the protocol for establishing IP security associations between the mobile node and the home agent does not survive movements. This bit is valid only for Binding Updates sent to the home agent. The Reserved (RSVD) 8-bit field 510 is reserved for future use. The Lifetime (LT) 16-bit data field 520 indicates the number of time units remaining before the binding expires. Each time unit is four seconds. The Mobility Options (MO) variable-length data field 530 contains any mobility options. The care-of address can be specified in either the Source Address field of the IPv6 header or in the mobility option data field.

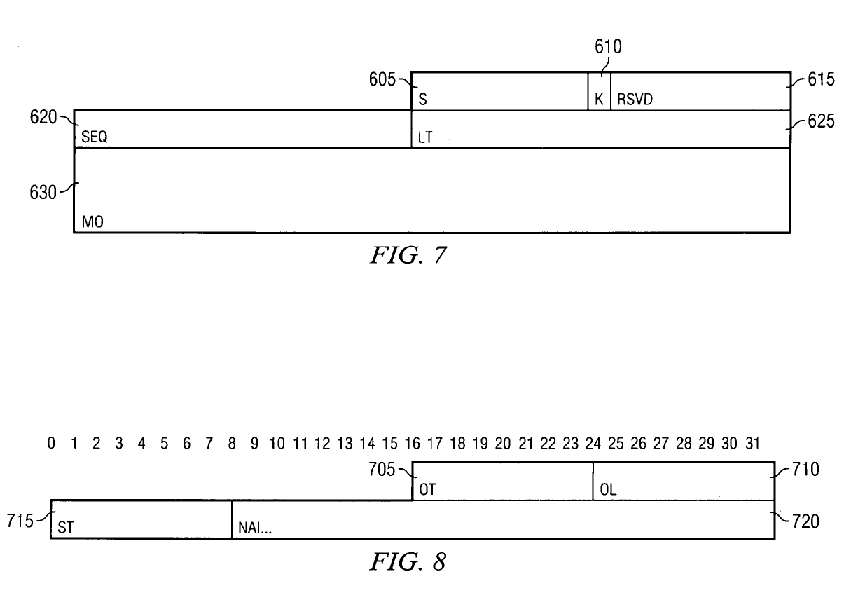

FIG. 7 shows a Binding Acknowledgment message (BA) extension format used in the invention. The extension occupies the Message Data data field of FIG. 5. The Status (S) 8-bit data field 605 indicates the disposition of the Binding Update message, with values of less than 128 indicating that the BU message was accepted by the receiving node. The Key Management Mobility Capability (K) one-bit data field 610, if cleared, indicates that the protocol for establishing IP security associations between the mobile node and the home agent does not survive movements. The Reserved (RSVD) 8-bit field 615 is reserved for future use. The Sequence Number (SEQ) 16-bit data field 620 is copied from the Sequence Number field in the BU and is used by the mobile node to match the BA with an outstanding BU. The Lifetime (LT) 16-bit data field 625 indicates the number of time units remaining before the binding expires. Each time unit is four seconds. The Mobility Options (MO) variable-length data field 630 contains any mobility options. The care-of address can be specified either in the Source Address field of the IPv6 header or in the mobility option data field.

FIG. 8 shows the Network Access Identifier (NAI) Carrying Extension used in the invention. The Option Type (OT) 8-bit data field 705 identifies the type of mobility option and designates the mobility option as an NAI. The Option Length (OL) 8-bit data field 710 specifies the length in octets of the subtype and NAI (e.g. does not include the OT 705 and OL 710 fields). The Subtype (ST) 8-bit data field 715 designates the subtype of NAI. In the invention, the subtype value will either designate the NAI Carrying Extension as a Home Agent (e.g. contains the NAI of a Home Agent) or as a Home AAA server (e.g. contains the NAI of a AAA server on the home network). For the Home Agent NAI, the subtype value will be “1”, and for the Home AAA Server NAI, the subtype value will be “2”. The NAI variable length data field (NAI) 720 contains the NAI of either a Home Agent (HA) or a Home AAA server (AAAH).

For the HA identity subtype of the NAI Carrying Extension, the NAI 720 is in the form of hostname@realm. Together, the hostname and realm forms the complete Fully Qualified Domain Name (FQDN) (hostname.realm) of the HA. A HA using the extension must provide it in the first BA message sent to the Mobile Node (MN) not currently registered. The extension only needs to be included in subsequent BA messages if the same extension is included in the BU messages received from the same MN. If the MN receives the extension in a BA message, then the MN using this extension must provide it in every subsequent BA when re-authentication is required. Failure to re-authenticate, such as when no AAAH can be reached, results in termination of the Mobile-IP session. Upon initiation of a new session, a new HA Identity NAI may be provided to the MN. If the MN requires a specific HA, then it must provide the extension of the HA in its initial BU request destined for the HA. The ability of the MN to specify a specific HA is an important aspect of the invention.

For the AAAH Identity subtype of the NAI Carrying Extension, the NAI 720 contains the NAI of the AAAH in the form of hostname@realm. Together, the hostname and realm forms the complete Fully Qualified Domain Name (FQDN) (hostname.realm) of the AAAH. If there are several AAA servers in the home network, a HA providing AAAH selection support must provide the AAAH identity in the first BU sent to the MN. This extension is only required in a subsequent BA message if the same extension is included in a BU message received from the same MN. A MN should save the latest AAAH Identity received in a BU message and should provide the AAAH Identity in every BU message sent when re-authenticating. The extension only needs to be included in subsequent BA messages if the same extension is included in a BU message received from the same MN. Failure to reach the indicated AAAH during re-authentication results in a new AAAH Identity NAI being returned. The new AAAH Identity is saved and provided in subsequent BU messages. Failure to re-authenticate, such as when no AAAH can be reached, results in termination of the Mobile-IP session. On initiation of a Mobile-IP communication session, a new AAAH Identity NAI may be provided to the MN for re-use during later re-registrations.

The NAI extensions permit dynamic allocation of HA and AAAH servers rather than random selection. Using the BU and BA messages with the NAI extensions, specific nodes can be selected as Home Agents and specific AAA servers can be selected to support a Mobile-IP session. This allocation makes network management easier and improves scalability. The MN can specify the HA and the AAAH to use, or the HA can specify the AAAH to use making network configuration of the AAAH server transparent to the MN. Using this protocol, the MN can also specifically select a security association because of the ability to specify the AAAH server and/or the HA which in turn can independently select the AAAH server under one embodiment.

A set of extensions allows the AAA server to supply key material to mobile nodes to use as the basis of a security association of a home agent with the mobile nodes. The key materials are both requested and supplied by options to the BU and BA messages respectively. Under the basic operation of the invention protocol, if the MN does not have a security association with the HA, it must add an MN-HA key Generation Nonce Request Extension as part of its BU message. If one or more AAA Key Generation Nonce Request options are added, the MN must add the MN-AAA authentication option to the BU. The MN's key requests and authentication data are transferred to the AAAH typically after reformatting into the appropriate AAA message format. After information within the MN-AAA extension is verified by the AAAH server, the AAAH server generates the key material requested by the MN to set the necessary security associations (SAs). The respective keys for these SAs are then distributed to the HA. A BA message communicates the key data from the HA to the MN. The MN in turn must create or update its Mobility SA with the HA using the key computed from the key data found in the MN-HA Key Generation Nonce found in the extension. The MN will use the SA with the HA to authenticate the BA by checking the authentication data in a Mobile-Home Authentication option. Once the shared SA is established, this shared SA will be used in all subsequent re-registrations.

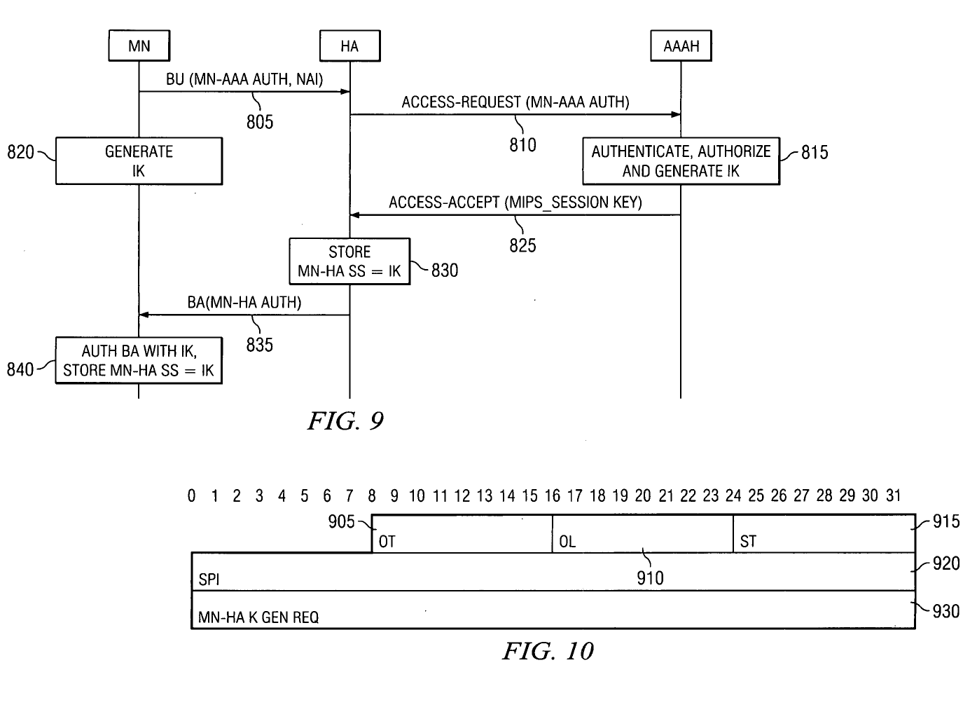

FIG. 9 shows the message flow of the invention implementing a security association by selectively specifying a given HA and AAAH pair to utilize in a Mobile-IP session. In step 805, a BU message is generated by a MN containing a MN-AAA Authentication option and NAI identity extension for a specific HA and a specific AAAH. The MN-AAA Authentication option is used to authenticate the BU message based on the shared security association between the MN and the AAAH, and the corresponding BA message must be authenticated using the MN-HA Authentication option. The BU message is routed to the identified HA, which examines the BU extracting the NAI for the specific AAAH server that is to be used in the Mobile-IP session.

In step 810, the HA generates and transmits an Access-Request message to the AAAH server specified in the BU NAI mobility option containing a MN-AAA Authentication option. In step 815, the AAAH server authenticates the MN based on the MN-AAA Authentication data. The MN-AAA Authentication includes a “shared secret” (SS), which is used in step 815 to generate a Session Key (IK) to use to secure communication between the MN and the HA. In step 820, the MN performs an identical generation to also generate the IK. In step 825, the AAAH generates an Access-Accept message that contains a session key containing the derived IK and transmits the Access-Accept message back to the HA.

In step 830, the HA stores the IK as a MN-HA shared secret (SS) to use in the Mobile-IP session to support secure information packet transmittal. In step 835, the HA transmits a BA message containing a MN-HA Authentication option based on the received IK. The MN-HA Authentication option is used to authenticate the BU and BA messages based on the shared-key (e.g. the IK) security association between the MN and the HA. After receipt by the MN, in step 840 the MN authenticates the BA message by computing the MN-HA authenticator with the IK that it derived in step 820. If this authentication step succeeds, the MN stores the derived IK for use as the MN-HA shared secret to support secure information packet transmissions during the Mobile-IP session. Once this shared SA is established, the shared SA will be used in all subsequent re-registrations.

FIG. 10 shows an embodiment for a MN-HA Generation Nonce Request Option extension that is used to request a MN-HA key on behalf of the MN. The 8-bit Option Type data field (OT) 905 designates the extension as containing MN-HA Key Generation Nonce Request data. The 8-bit Option Length data field (OL) 910 is the length of the option beginning with the Subtype data field in octets. The 8-bit Subtype data field (ST) 915 is a number assigned to identify how the MN-HA Key Generation Nonce Request data is used to generate the registration key. The 32-bit Security Parameter Index data field (SPI) 920 is assigned for the Mobility Security Association created for use with the registration key. The variable length MN-HA Key Generation Nonce Request data field (MN-HA K GEN REQ) 930 contains the data needed for the AAAH to create the MN-HA key on behalf of the MN.

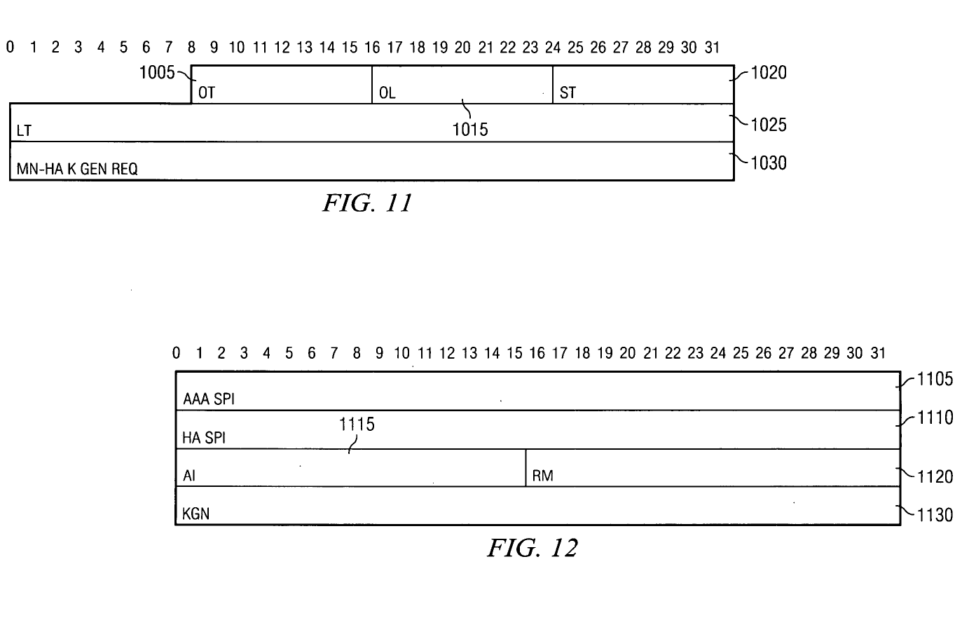

FIG. 11 shows an embodiment for a MN-HA Generation Nonce Reply Option extension that is used to reply to a request for a MN-HA key on behalf of the MN. The 8-bit Option Type (OT) data field 1005 designates the extension as containing MN-HA Key Generation Nonce Reply data. The 8-bit Option Length (OL) data field 1010 is the length of the option beginning with the Subtype data field in octets. The 8-bit Subtype (ST) data field 1015 is a number assigned to identify how the MN-HA Key Generation Nonce Request data is used to obtain the MN-HA key. The 32-bit Lifetime (LT) data field 1020 indicates the duration of time (in seconds) during which the MN-HA key is valid. The variable length MN-HA Key Generation Nonce Request (MN-HA K GEN REP) data field 1030 contains the data required for the MN to derive the MN-HA key and any other information required by the MN to create a designated Mobility SA with the HA. For each subtype, the format of the data has to be separately defined according to the particular method required to set up the SA.

FIG. 12 shows an embodiment for a MN-HA Generation Nonce from AAA extension that is used to provide a key generation nonce from the AAAH server to the MN. The 32-bit AAA Security Parameter Index (AAA SPI) data field 1105 is an opaque value that the MN uses to determine the transform to use for establishing the Mobility SA between the MN and the HA. The 32-bit HA Security Parameter Index (HA SPI) data field 1110 is the SPI for the Mobility SA to the HA that the MN creates using the Key Generation Nonce. The 16-bit Algorithm Identifier (Al) data field 1115 indicates the transform operation to be used for future computations of any Mobile-Home Authentication Extension. The 16-bit Reply Method (RM) data field 1120 contains the replay method to use for future BU messages. The variable length Key Generation Nonce (KGN) data field is a random value of at least 128 bits generated by the AAAH. The MN calculates the MN-HA key using this key. The calculation proceeds by using the key shared between the mobile node and the AAAH server. The derived MN-HA key is used to secure Mobile IP registration message transmitted between the MN and HA and can also be used for other information packet transmissions between the MN and the HA.

While the invention has been particularly shown and described with respect to preferred embodiments, it will be readily understood that minor changes in the details of the invention may be made without departing from the spirit of the invention.

1. A communication system, comprising:
a home network having one or more Authentication, Authorization, and Accounting servers storing security association data having a communication link to a home agent on the home network;
a mobile node connected to a foreign network, said mobile node transmitting and receiving information packets secured by a security association between the mobile node and the home agent, said security association is provided by a designated Authentication, Authorization, and Accounting server on the home network; and
a first information packet requesting security association data for use by the mobile node and the home agent, said first information packet received by an Authentication, Authorization, and Accounting server designated by a data element contained in the first information packet.

2. The communication system of claim 1 wherein the data element originates at the mobile node.

3. The communication system of claim 1 wherein the data element originates at the home agent.

4. The communication system of claim 1 further comprising:
a second information packet registering the mobile node connection to the foreign network received by a home agent, said home agent designated by a data element contained in the second information packet.

5. The communication system of claim 2 further comprising:
a second information packet registering the mobile node connection to the foreign network received by a home agent, said home agent designated by a data element contained in the second information packet.

6. The communication system of claim 1 further comprising:
a third information packet generated by the Authentication, Authorization, and Accounting server received by the home agent containing one or more data elements to establish the security association between the home agent and the mobile node; and
a fourth information packet received by the mobile node containing one or more data elements to establish a security association between the home agent and the mobile node provided by the Authentication, Authorization, and Accounting server.

7. The communication system of claim 6 wherein the security association data includes a derived session key used by the mobile node and the home agent to secure a transmitted information packet.

8. The communication system of claim 1 wherein the Authentication, Authorization, and Accounting server on the home network is designated by a data element in an information packet received from the mobile node at the home agent.

9. A method of establishing a secured information packet communication between a mobile node on a first network and a home agent on a second network comprising the steps of:
connecting a mobile node to said first network;
transmitting a first information packet from the mobile node on said first network, said first information packet having an extension containing an address for said home agent on the second network, an address for a designated Authentication, Authorization, and Accounting server on the second network, and a care-of address for the mobile node on the first network; and
transmitting a second information packet on said second network, said second information packet containing security association data for use by said home agent and said mobile node to secure communication between the home agent and the mobile node, and said security association data generated by said designated Authentication, Authorization, and Accounting server.

10. The method of establishing a secured information packet communication between a mobile node on a first network and a home agent on a second network of claim 9 wherein the first information packet is a binding update message.

11. The method of establishing a secured information packet communication between a mobile node on a first network and a home agent on a second network of claim 9 wherein the second information packet is a binding acknowledgment message.

12. The method of establishing a secured information packet communication between a mobile node on a first network and a home agent on a second network of claim 11 wherein the second information packet contains a session key for securing an information packet communication.

13. The method of establishing a secured information packet communication between a mobile node on a first network and a home agent on a second network of claim 9 further comprising the steps of:
storing a session key generated by the Authentication, Authorization, and Accounting server on the home agent; and
storing a session key generated by the Authentication, Authorization, and Accounting server on the mobile node.

14. The method of establishing a secured information packet communication between a mobile node on a first network and a home agent on a second network of claim 13 further comprising the steps of:
transmitting a nonce request to the Authentication, Authorization, and Accounting server designated in the first information packet;
transmitting a nonce reply containing the address for the home agent transmitted in the first information packet containing a generated nonce data element; and
using said generated nonce data from the Authentication, Authorization, and Accounting server used to secure a third information packet transmitted between the mobile node and the home agent.

15. The method of establishing a secured information packet communication between a mobile node on a first network and a home agent on a second network of claim 9 wherein security association data includes an authentication algorithm and shared key.

16. The method of establishing a secured information packet communication between a mobile node on a first network and a home agent on a second network of claim 11 wherein a security association is stored on said designated Authentication, Authorization, and Accounting server.

17. A set of information packet communications implementing a secure communication protocol between a mobile node and a home agent, comprising:
a first information packet containing a data element designating a home agent on a home network and a data element designating an Authentication, Authorization, and Accounting server on the home network;
a second information packet containing a data element requesting a security association context from said designated Authentication, Authorization, and Accounting server; and
a third information packet containing a data element for a security association context for use on said home agent and said mobile node.

18. The set of information packet communications implementing a secure communication protocol between a mobile node and a home agent of claim 17 wherein the third information packet comprises a binding acknowledgment message.

19. The set of information packet communications implementing a secure communication protocol between a mobile node and a home agent of claim 17 wherein the first information packet is a binding update message.

20. The set of information packet communications implementing a secure communication protocol between a mobile node and a home agent of claim 17 wherein:
the Authentication, Authorization, and Accounting server generates a session key used by the mobile node and the home agent to secure a fourth information packet; and
the session key for the mobile node is transmitted to the mobile node in a binding acknowledgment message.
